(19) United States
(12) Patent Application Publication
(10) Pub. No.: US 2005/0162086 A1
(43) Pub. Date: Jul. 28, 2005

(54) Plasma display panel with microwave radiation discharge excitation

(76) Inventors: Ana Lacoste, Saint Martin Le Vinoux (FR); Laurent Tessier, Fontaine (FR); Henri Doyeux, Beaucroissant (FR)

Correspondence Address: Joseph S Tripoli;Thomson Licensing Inc, Patent Operations, PO Box 5312, Princeton, NJ, 08543-5312, US

(21) Appl. No.: 10/513,093

(22) PCT Filed: Apr. 10, 2003
(86) PCT No.: PCT/FR03/01130

(30) Foreign Application Priority Data
Apr. 30, 2002 (FR) 02/05420

(51) Int. Cl. H01J 11/00; H01J 17/49

(52) U.S. Cl. 313/586; 313/582

(57) ABSTRACT

The invention concerns a display panel comprising a front faceplate and a rear faceplate providing between them a two-dimensional matrix of zones filled with discharge gas, addressing means for selectively activating pre-selected discharge zones by depositing therein electric charges, and a device for generating microwave electromagnetic radiation adapted to apply through the rear faceplate to the assembly of the display panel discharge zones, a microwave radiation of sufficient intensity to generate plasma discharges solely in the activated discharge zones. Thus, an easy-to-monitor panel with high luminous efficacy is obtained wherein the addressing and maintenance functions are separate.

The invention relates to a plasma display panel with discharge excitation by microwave radiation and to a method of driving this panel.

The basic operational principle of plasma screens relies on the initiation and sustaining of plasma discharges, between two electrodes, in elementary cells filled with a discharge gas forming a two-dimensional matrix array between two flat plates, generally made of glass. These electrodes are covered with dielectric layers in order to provide a well-known memory effect, hence the need to use sustain voltages in the form of pulses or AC sustain voltages in order to produce the discharges. Depending on the frequency of the applied sustain signals, the technologies developed hitherto for plasma display panels (PDPs) may be grouped into two, categories, namely AC-PDP and RF-PDP technologies. For AC (alternating current) structures, the frequency of these pulses is a few hundred kHz or less, whereas for RF (radiofrequency) structures their frequency is around ten or several tens; of MHz; document JP 10-17.13999 (Hitachi) describes an RF-type structure.

The dielectric layers covering the electrodes, between which the discharges occur, act as capacitors capable of storing electrical charges, thereby giving the cells in which a discharge has taken place a memory effect. This memory property relies on the cells being addressed, at the start of each image scan or subscan to be displayed, by applying low-frequency address voltage pulses, this being the case whatever the PDP structure. The voltage of these address pulses is designed to deposit electrical charges on the walls of the cells at a suitable level for the sustain signals to generate discharges only in the addressed regions. The essential difference between the two technologies—AC and RF—therefore lies in the mode in which the discharges are sustained during the image subscans, namely at low frequency and at radiofrequency respectively. The two modes differ by the actual principle of operation of the discharges, but only the aspects relating more particularly to plasma panels will be discussed here, namely the light efficiency and the lifetime of the cell surfaces:
i) the AC discharge mode leads to the formation of a highly energetic cathode sheath which reduces the part of the electron energy dissipated in the excitation of the rare discharge gas in the cells, and consequently to a reduction in the number of VUV photons produced. This results in a poor luminous efficiency, but also in a low lifetime of the surfaces of the cell structure due to their bombardment by energetic ions from the discharges;
ii) as illustrated in FIG. 1, in an RF discharge the potential difference between the plasma VSh and the electrodes VE is practically half the potential applied to the electrodes and, consequently, the energy of the ions is practically half that of an AC discharge. This makes it possible to reduce the power dissipated in the sheath and consequently to increase the energy contribution assigned to the electrons of the discharge. To give an example, the energy contribution assigned to the electrons compared to the total energy assigned to the discharge is estimated to be 75%; compared with only 40% in an AC structure. The reduction in the energy of the ions in the sheath allows the luminous efficiency to be improved and the lifetime of the cell surfaces to be extended.

The dielectric layers are in general coated with protective layers, generally based on magnesia (MgO), which also serve for the emission of secondary electrons under ion bombardment.

The main drawbacks of the RF structures developed hitherto are:
the problem of coupling between the lines constituting the RF electrode;
the difficulty of producing a uniform RF field over large areas formed by plasma panels;
the low electrical efficiency due to losses in the conduction lines, the connections and tuning box.

The object of the invention is to remedy the drawbacks intrinsic to plasma screens using plasma cells operating in dielectric-barrier discharge mode with low-frequency or radiofrequency sustaining.

For this purpose, the subject of the invention is a plasma display panel comprising a front plate and a rear plate, leaving between them a two-dimensional matrix of regions filled with a discharge gas, characterized in that it includes a microwave electromagnetic radiation generator for applying, through the said rear plate to all of the said discharge regions, microwave radiation of sufficient intensity to generate plasma discharges in the discharge regions.

The display panel obtained is similar to, and much simpler and less expensive than, the display devices described in documents EP 0 511 282 and EP 0 377 442, which are based on a two-dimensional array of electrodeless fluorescent lamps.

Preferably, the display panel according to the invention also includes address means for selectively activating preselected discharge regions by depositing electrical charges therein, and the microwave electromagnetic radiation generator is designed to apply microwave radiation of sufficient intensity to generate plasma discharges only in the activated discharge regions.

The microwave field therefore serves to sustain the plasma discharges in the addressed cells, but, in the preferred embodiment of the invention, its amplitude is insufficient by itself to generate discharges in the non-activated or addressed cells; preferably, the address means also serve not only to initiate the discharges in the preselected regions or cells as soon as the microwave, field is applied to the entire panel, but also to re-initiate these discharges at al sufficient intensity level during application of the microwave field; such “re-initiations” ensure that the charges are sustained within the volume of the activated cells or regions.

The invention may also have one or more of the following features:
the microwave electromagnetic radiation generator is suitable for generating microwaves with a frequency of greater than 200 MHz;
the rear plate has no electrode array nor any conducting layer nor conducting layer segment; the rear plate is made of a dielectric material having low dielectric losses in the frequency range of the said microwave radiation. Thus, the rear plate is transparent to the microwave radiation; this rear plate may for example be made of glass;
the front plate includes at least two addressing electrode arrays, each electrode of a first array crossing each electrode of a second array at the location of a discharge region of the two-dimensional array of discharge regions.

According to the invention, all the electrodes of the panel are therefore preferably placed on the front plate; according to a variant, the front plate comprises three electrodes arrays, including two electrode arrays that are parallel, paired and coplanar.

The subject of the invention is also a method of driving the panel according to the invention, comprising a succession of image scans and subscans, in which each subscan comprises a cell address phase, which cells are preselected by means of the address means of the panel, and a sustain phase, characterized in that the microwave field is applied to all the cells of the panel during the sustain phase.

This microwave field may be applied continuously throughout the sustain phase, or in a discontinuous manner.

Advantageously, during the sustain phase, a conventional “low-frequency” sustain signal is furthermore applied, using address electrodes or other electrodes, in all the discharge regions of the panel so as to sustain the charges within the volume of the addressed regions.

Thus, the invention proposes a novel cell structure based on increasing the frequency of the discharge sustain signal up to within the microwave range (f>200 MHz). In a microwave; plasma, practically all the energy will be devoted to the ionization and excitation of the gas, thus allowing the luminous efficiency to be increased.

The solution provided by the invention consists in preferably addressing the cells by means of low-frequency signals, using the current techniques and circuits of commercial panels, and in sustaining the discharge by a high-frequency field in the microwave range (f>200 MHz).

The advantages of the invention are mainly the following:
a) the main advantage of the invention is the increase in luminous efficiency. This because the energy dissipated in a microwave plasma is entirely devoted to the excitation and ionization of the gas. The absence of plasma sustain electrodes means that, apart from the low-frequency pulses, there is no ion bombardment and spraying of the walls, and therefore little or no energy dissipated in this form. This is because the cell walls of the panel are at floating potential, which means that the energy of the ions striking these walls does not exceed around ten electron volts. Consequently, the lifetime of the magnesia protective layer is considerably extended, which substantially improves the lifetime of the panel.

The electron population of a microwave plasma generally has an energy distribution function close to a Maxwell curve of a few eV, depending on the pressure range, whereas that of a low-frequency or radiofrequency discharge is a function that also includes a large population of highly energetic electrons, the secondary electrons. These highly energetic electrons favour ionization and excitation of the higher energy levels to the detriment of the excitation of low-energy levels, mainly responsible for producing UV photons. The absence of this electron population in a microwave plasma therefore makes it much more effective for UV production.

A high cell luminous efficiency may be obtained by choosing gases or gas mixtures that allow the production of UV photons to be optimized. In fact, with microwave excitation, the choice of the gas and of the working pressure is considerably wider compared with the constraints with low-frequency and radiofrequency discharges. In other words there is considerable latitude in choosing the ideal operating point of the plasma cells;
b): one key advantage of this invention is that the injection of power via the rear face on the one hand, and the addressing of the cells by electrodes on the front face on the other, will; follow different channels, thus allowing separation of the functions;
c) another advantage is the simplicity of the proposed technology both as regards the structure of the cells and as regards the way they are addressed. For example, the matrix array of row (or line) and column electrodes may be produced by simple intersection technology, with narrow electrodes. Since these electrodes are used only for low-frequency control, there is no longer any need for wide electrodes in order to ensure a memory charge during the sustain phase and therefore a memory margin (as discussed above);
d) the limitation on excessively high breakdown voltages is imposed by the components of the control electronics and no longer by the power consumption since cell control requires only a minimum of pulses per image and the value of the pulse voltage is no longer a critical parameter. In contrast, from the standpoint of operating margins, the high breakdown voltages will ensure very large margins. However, the risk of breakdown in the dielectric interposed between the row and column electrodes requires dielectric thicknesses of several tens of microns;
e) erasing the memory charge during the microwave sustain phase gets round the problem of the erase pulse preceding each image subscan. In the panel structures of the prior art, this pulse is essential in order to cancel out the memory charge at the end of each sustain cycle and thus to reset the cells. This erase pulse is even necessary in the case of a radiofrequency sustain phase. The slightest dissymmetry or difference in radiofrequency electrode area may result in a dissymmetry in the electrode potentials, with consequently residual memory charges at the end of a sustain cycle;
f) the luminous intensity of the elementary cells is controlled by the duration of application of the microwave field, from the moment that the plasma is struck to the end of the image; and
g) the dimensions of the cells and the total operating pressure of the cells remain of the same order of magnitude as with the current technology, with however a very much greater operating latitudes. In this technology, the height of the barrier ribs is no longer a critical parameter, as is the case in the radiofrequency technology for which it is necessary to control the fabrication technology for barrier ribs exceeding 500 μm in height.

The invention will be more clearly understood on reading the description that follows, given by way of non-limiting example, and with reference to the appended figures in which:

FIG. 1 illustrates a comparison between the operation of a panel with an AC structure and a panel with an RF structure of the prior art, as regards the discharges (V_{Sh}=sheath voltage in the discharge and V_{E}=electrode voltage in the cell where the discharge takes place);

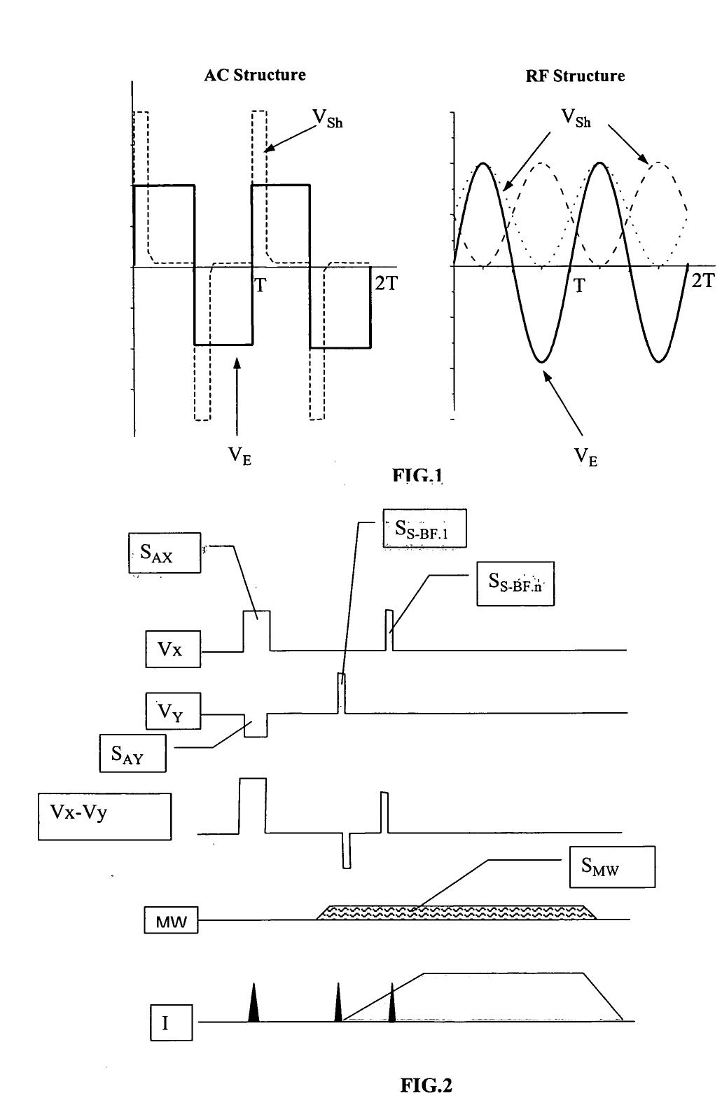

FIG. 2 illustrates the timing diagrams for application of the address voltage signals S_{AX} and S_{AY}, to the electrodes X and Y respectively, and of the microwave signals S_{MW} on the rear face in one way of implementing the method of driving a plasma panel according to the invention;

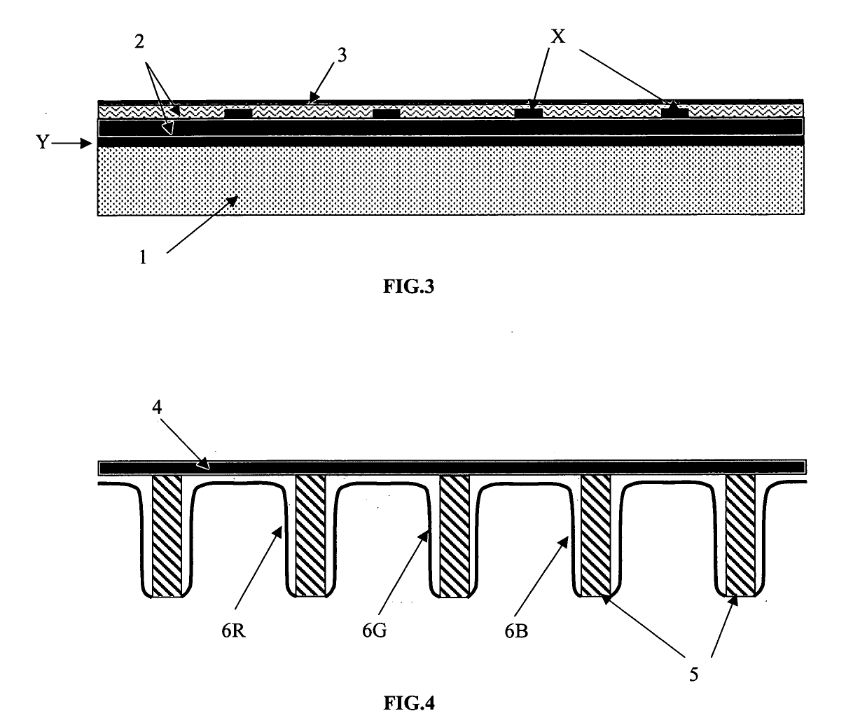

FIGS. 3, 4, and 5 how a sectional schematic view of the front plate, the rear plate and the entire plasma panel, respectively, in one embodiment according to the invention;

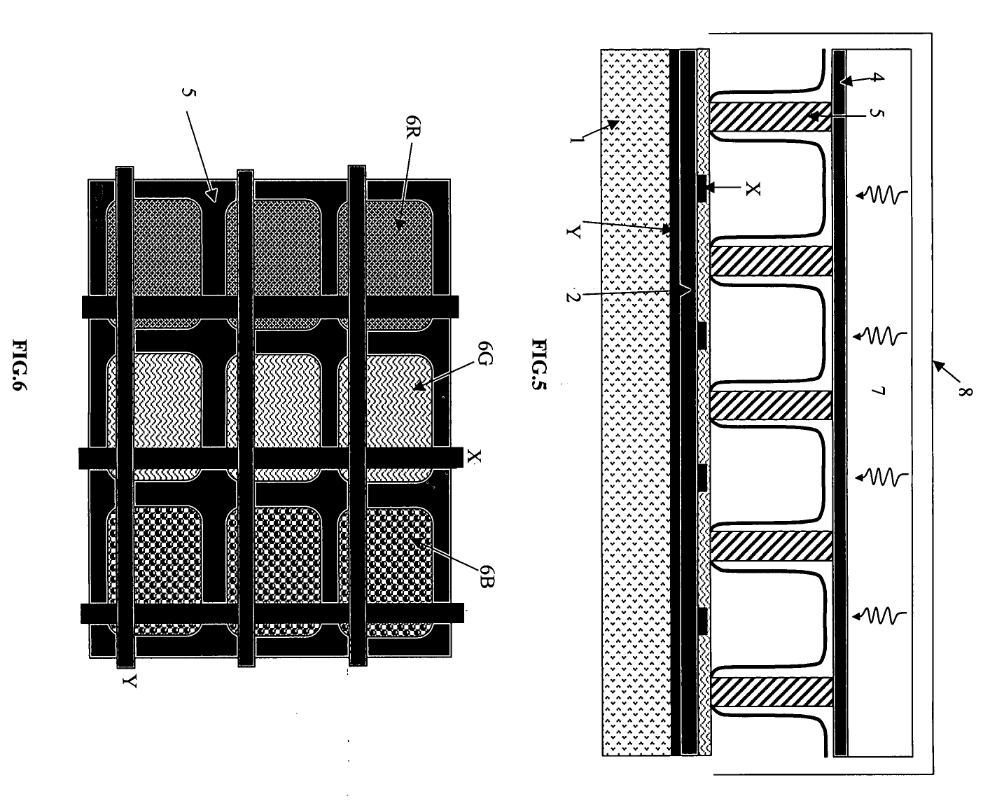

FIG. 6 shows in a top view, a variant of the panel according to FIG. 5, in which the intersections of the electrodes on the front plate are offcentred relative to the centre of the cells;

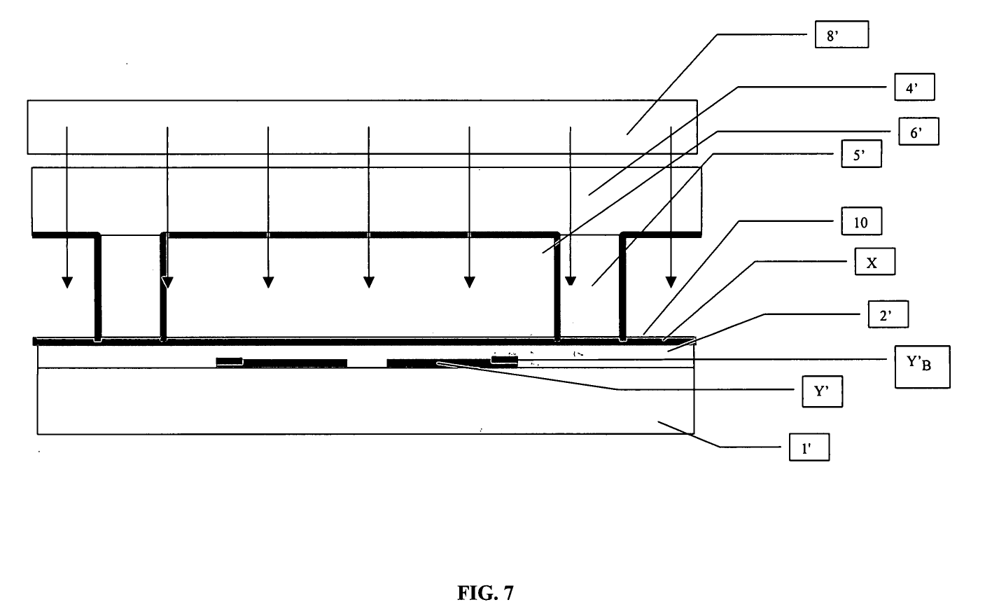

FIG. 7 shows a variant of the panel according to FIG. 5, in which the front plate has three electrode arrays, two electrode arrays of which are parallel, paired and coplanar;

FIG. 8 shows, in a top view, a variant of the panel according to FIG. 7, in which each electrode of the paired arrays serves for two adjacent rows of cells and is placed on top of the barrier ribs that separate the cells; and

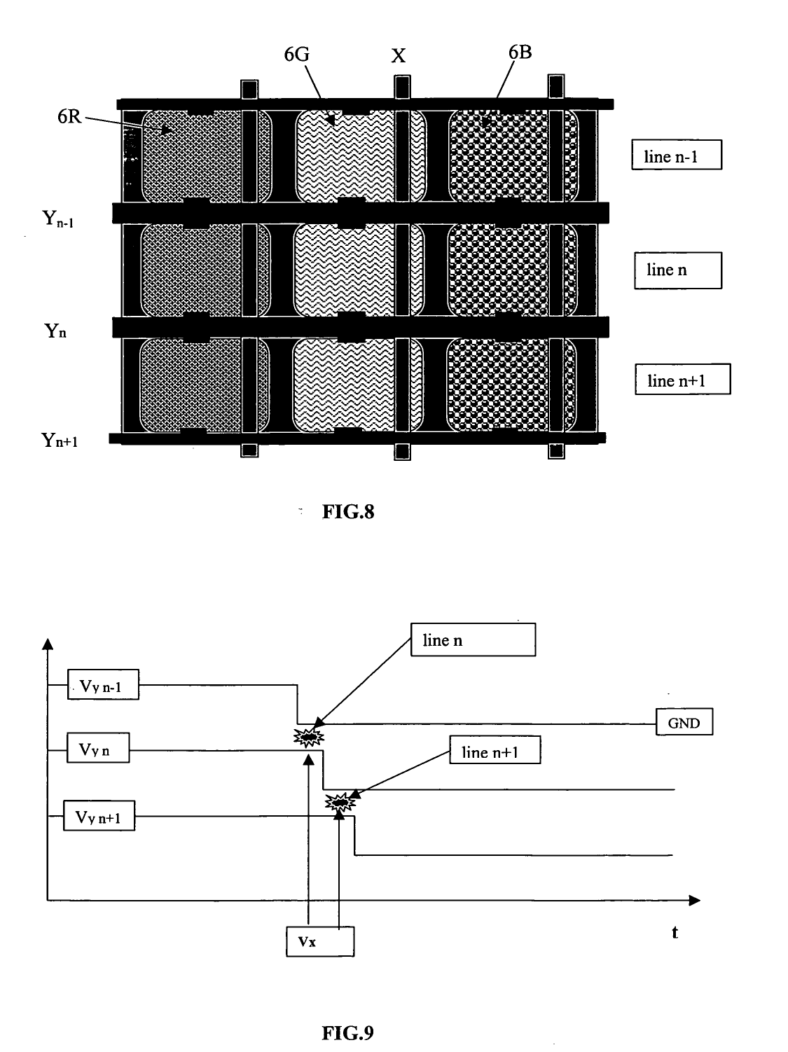

FIG. 9 illustrates a timing diagram for the voltages applied to the row electrodes Yₙ₋₁, Yₙ, and Yₙ₊₁ for initiating the discharges in the panel of FIG. 8.

The figures showing timing diagrams do not reflect the actual scale of value so so that certain details are to be more clearly visible, details which not be clearly visible if the proportions had been respected.

The production of the plasma panel according to the invention will now be described; this starts with the description of the front plate and then of the rear plate, both of which are intended for manufacturing this panel:
i) as illustrated in FIG. 3, the addressing and the initiation of the discharge take place by means of a matrix array of electrodes located on the front plate of the panel. The column electrodes Y of a first array, deposited on a glass substrate 1, intersect the row electrodes X of a second array. The two arrays are separated by a dielectric layer 2. The second electrode array is coated with a dielectric layer 2 and with a magnesia-based protective layer 3, the latter also acting as a surface for emitting secondary electrons. The thickness of the dielectric layer 2 is adapted in a manner known per se, in particular according to the nature and the pressure of the discharge gas that will fill the panel;
ii) the application of the microwave power in a discharge does not take place by means of electrodes and, consequently, the structure of the rear plate, via which the microwaves are applied, must be designed appropriately. As illustrated in FIG. 4 the rear face is completely devoid of any electrode or conducting layer, and mainly comprises a substrate 4 made of a low-loss, rigid and impermeable dielectric. The dielectric is preferably one having low losses in the frequency range of the microwaves used. This substrate 4 comprises an array of barrier ribs 5 forming cavities designed to be centred with respect to the intersections of the X and Y electrodes on the front plate. The walls of these cavities are coated with phosphors 6R, 6B, 6G so as to obtain, through the excitation of the ultraviolet emitted by the plasma discharges, visible photons in the three primary colours for displaying images, namely red, green and blue. These cavities form the cells of the panel.

Next, the front plate is joined to the rear plate in a manner known per se, by superposing them so that each electrode intersection on the front plate coincides with a cell of the rear plate.

The pressure of the discharge gas within such a microwave-sustain panel will preferably be lower, for example by a factor of about 10, than the pressure of discharge gas within conventional AC sustain plasma panels.

The plasma panel is then provided on its rear face with a microwave device suitable for applying a microwave field over the entire surface of the dielectric substrate 4 corresponding to the active part of the panel.

The structure of the panel obtained is shown in FIGS. 5 and 6. In order for the microwave power, applied at the rear 7 of the rear plate, of the panel, to provide a uniform field over the entire surface of the said rear plate, the microwave device includes a field amplitude regulator that imposes an upper limit during each image subscan, the said limit being determined by the sustain field, corresponding to the sustain voltage, to which a voltage margin corresponding to around twenty volts per cell is added. The amplitude of the field is adapted in the manner known per se so as to be able to sustain all the cells of the panel, but is low enough not to cause the non-addressed cells to be initiated.

To avoid microwave radiation, the rear face of the panel is provided with a microwave screen 8. On the front face, the microwave screen is provided by the matrix array of electrodes.

Since the small width of the electrodes does not impair the cell fill factor, the filling is provided by diffusion of the microwave plasma throughout the volume of the cell. As illustrated in FIG. 6, the position of the electrodes X and Y may be off-centre relative to the centre of the cells so as to increase the transparency of the front plate to the visible radiation, while still remaining, however, quite far from the barrier ribs so as not to significantly increase the strike voltages.

FIG. 7 shows a variant of the panel according to FIG. 5, in which the front plate comprises three arrays of electrodes, including two arrays of parallel, paired and coplanar electrodes Y′; the components referenced bear the same references (apart from the (“′”symbol) as the components referenced in FIG. 5; the reference 10 corresponds to the magnesia layer and the reference Y′_{B} corresponds to an opaque conductor bus applied to the transparent electrodes Y′ in order to increase their conductivity FIG. 8 shows a variant of the panel of FIG. 7, in which each electrode of the paired arrays serves for two rows of adjacent cells and is placed above the barrier ribs that separate the cells; thus, the widest aperture for passage of the light is advantageously provided for each cell; two consecutive “row” electrodes therefore form a pair for the row of cells that they flank, thereby making it possible to obtain a large gap at each cell; the protuberances placed on the “row” electrodes at each cell facilitate the initiation of the discharges.

FIG. 9 illustrates a timing diagram for the voltages applied to the row electrodes Yₙ−1, Yₙ, and Yₙ+1 for initiating discharges in the panel of FIG. 8, with a suitable pulse Vₓ applied via the column electrode X, especially during address phases.

One method of driving the panel according to the invention will now be described with reference to FIG. 2, which consists:
a) in addressing the cells by applying, between the row electrodes X or scanning electrodes and the column electrodes Y or data electrodes, a pulse of amplitude V_{X}+V_{Y} greater than the plasma strike voltage. The discharges thus initiated result in the creation of the memory surface charge in the cells addressed;
b) in applying, through the rear plate, a microwave electric field MW uniformly distributed over the entire rear face of the panel. The amplitude SMW of the microwave field MW must be greater than the electric field needed to sustain the plasma, but less than the electric field for initiating the discharge in the cell;
c) in initiating the discharge in the addressed cells by applying a few pulses S_{S-BF.1}, . . . , S_{S-BF.n}, etc. to the control electrodes in order to create the volume charges. The amplitude of these signals added to the voltage due to the memory charge and to the voltage corresponding to the microwave field must be greater than the plasma strike voltage. The amplitude of these signals alone must be less than the plasma strike voltage. Thus, during the sustain phase, a conventional “low-frequency” sustain signal S_{S-BF.1}, . . . , S_{S-BF.n}, etc. is applied in all the discharge regions of the panel so as to sustain the charges within the volume of the addressed regions. The sustaining of the volume charges, that is to say the creation of charges that compensate for the losses by diffusion to the walls and by recombination, is provided by the microwave field applied to the entire surface of the set of cells. According to point b), this field is not sufficient to initiate the discharge in the non-addressed cells; and
e) in extinguishing the plasma at the end of each image subscan by cutting-off the applied microwave field (OFF state).

The operating margins are determined by the low-frequency breakdown and microwave extinction voltages since, during the plasma discharge microwave sustain phase, the memory charge is completely erased, no longer influencing the extinction voltages.

The last timing diagram I shows very schematically the ultraviolet light emission intensity of the discharges resulting from the driving method that has just been described.

The present invention has been described mainly with reference to a plasma panel in which the two arrays of electrodes are carried by the front plate and in which the array of barrier ribs is carried by the rear plate, referring to a driving method in which the microwave field is applied continuously during an image subscan; it is obvious to a person skilled in the art that it may be applied to other types of plasma panel or to other driving methods without departing from the scope of the claims below.

1. Plasma display panel comprising a front plate and a rear plate, leaving between them a two-dimensional matrix of regions filled with a discharge gas, and address means for selectively activating the preselected discharge regions by depositing the electrical charges thereon, wherein it includes a microwave electromagnetic radiation generator for applying, through the said rear plate to all of the said discharge regions, microwave radiation of sufficient intensity to generate plasma discharges only in the activated discharge regions.

2. Panel according to claim 1, wherein the microwave electromagnetic radiation generator is suitable for generating microwaves with a frequency of greater than 200 MHz.

3. Panel according to claim 1, wherein the said rear plate has no electrode array nor any conducting layer nor conducting layer segment.

4. Panel according to claim 1, wherein the said rear plate (is made of a dielectric material having low dielectric losses in the frequency range of the said microwave radiation.

5. Panel according to claim 1, wherein the said front plate includes at least two addressing electrode arrays, each electrode of a first array crossing each electrode of a second array at the location of a discharge region of the said two-dimensional array.

6. Method of driving the panel according to claim 1, comprising a succession of image scans and subscans, in which each subscan comprises a cell address phase, which cells are preselected by means of the said address means, and a sustain phase, wherein the microwave field is applied to all the cells of the panel during the said sustain phase.
